(19) United States
(12) Patent Application Publication
(10) Pub. No.: US 2017/0098818 A1
(43) Pub. Date: Apr. 6, 2017

(54) SOLVENT-FREE DRY POWDER-COATING METHOD FOR ELECTRODE FABRICATION

(71) Applicant: The University of Kentucky Research Foundation, Lexington, KY (US)

(72) Inventors: Yang-Tse Cheng, Lexington, KY (US); Susan A. Odom, Lexington, KY (US); Mohanad N. Al-Shroofy, Lexington, KY (US); Kozo Saito, Lexington, KY (US); Qinglin Zhang, Lexington, KY (US); Jiagang Xu, Lexington, KY (US)

(21) Appl. No.: 15/283,697

(22) Filed: Oct. 3, 2016

Related U.S. Application Data
(60) Provisional application No. 62/236,171, filed on Oct. 2, 2015.

(51) Int. Cl. H01M 4/04; H01M 4/133; H01M 4/134; H01M 4/1391; B05D 1/06; H01M 4/1395; H01M 4/66; H01M 4/62; H01M 10/0525; H01M 10/0585; H01M 4/131; H01M 4/1393

(52) U.S. Cl. CPC H01M 4/0419; H01M 4/131; H01M 4/133; H01M 4/134; H01M 4/1391; H01M 4/1393; H01M 4/1395; H01M 4/661; H01M 4/662; H01M 4/623; H01M 4/624; H01M 10/0525; H01M 10/0585; B05D 1/06

(57) ABSTRACT

Electrostatic dry powder spray processes are disclosed for making battery electrodes. The electrodes made by dry powder coating processes are conventional lithium ion battery electrodes and unconventional electrodes of gradient in composition and structure, large thicknesses, free-standing, and flexible.

### RELATED APPLICATIONS

This application claims priority to U.S. Provisional Patent Application 62/236,171, filed Oct. 2, 2015, all of which is hereby incorporated by reference in its entirety.

### GOVERNMENT SUPPORT

This invention was made with government support from the National Science Foundation grant 1355438. The government may have certain rights in the invention.

### FIELD OF THE INVENTION

The present invention relates generally to methods for fabricating battery electrodes by electrostatic dry powder coating processes.

### BACKGROUND

As reported by the US Department of Energy, “revolutionary breakthroughs in electrical energy storage have been singled out as perhaps the most crucial need for this nation's secure energy future.” (Goodenough, J. B., H. Abruna and M. Buchanan (2007). Basic research needs for electrical energy storage. Report of the basic energy sciences workshop for electrical energy storage, U.S. Dept of Energy). As the nation's third largest automobile manufacturing state, Kentucky's automobile manufacturing base is critical to its and the nation's economy; thus, energy storage has been a focus of KY economic development strategy (“Intelligent Energy Choices for Kentucky's Future, Kentucky's 7-Point Strategy for Energy Independence,” GOVERNOR STEVEN L. BESHEAR November 2008, available online see eec.ky.gov/Documents/Kentucky%20Energy%20Strategy.pdf; 2012 Kentucky Science and Innovation Strategy see: www.kynsfepscor.org/Plans/pdfs/SI_Strategy_2-14-12_opt.pdf).

The present invention offers an approach at replacing several costly and environmentally unfriendly manufacturing steps in the conventional electrode fabrication process, specifically mixing and coating, with an innovative, low-cost, and environmentally-friendly dry-coating process. The invention provides a low cost manufacturing technology that will help achieve the goals of the US DRIVE “Electrochemical Energy Storage Technical Team Roadmap” (U.S. DRIVE Partnership (2013). Electrochemical Energy Storage Technical Team Roadmap, see: www1.eere.energy.gov/vehiclesandfuels/pdfs/program/eestt_roadmap_june2013.pdf).

Conventional, state-of-the-art, slurry mixing and coating processes are over 100 years old and have been recognized as “slow, high-cost, low-quality steps in battery manufacturing” (Communications between Kentucky Cabinet for Economic Development and Jeff Chamberlain, Deputy Director of Development & Demonstration for the Joint Center for Energy Storage Research). The mixing process is used to produce a slurry that consists of active material, polymer binder, conductive filler, and organic solvent (Tagawa, K. and Brodd, R. (2009). Production Processes for Fabrication of Lithium-Ion Batteries. Lithium-Ion Batteries. M. Yoshio, Brodd, R. and Kozawa, A. New York, Springer New York: 181-194). When an appropriate viscosity is obtained to achieve the required mass loading, the slurry is then coated onto a conductive metal foil. Afterward, because of the large amount of organic solvent used, the coating must be dried in an oven for several hours before it is calendered to form the desired thickness and porosity. Evaporation of the organic solvent consumes energy, requires the use of a large amount of material that is not part of the final product, and has a negative environmental impact. According to a recent ORNL study, the convention NMP solvent-based processing costs about $38.3 kWh⁻¹ which is about 14.5% of cell construction (Wood, D. L., J. Li and C. Daniel (2015). “Prospects for reducing the processing cost of lithium ion batteries.” Journal of Power Sources 275: 234-242).

In contrast, dry powder coating processes, developed over the past 30 years for decorative and functional paints and coatings, reduce the release of volatile organic compounds, reduce energy consumption, increase paint material transfer efficiency, and improve painted-surface quality (Brun, L. C., R. Golini and G. Gereffi (2009). The Development And Diffusion Of Powder Coatings In The US And Europe. Center on Globalization, Governance & Competitiveness, Duke University). Typically, dry powders are electrostatically sprayed onto the surface and then cured under heat, which allows the coated material to flow, thus forming a strongly-bonded uniform thickness coating layer (Akafuah, N. K. (2013). Automotive paint sprays visualization and characterization. Automotive painting technology: a Monozukuri-Hitozukuri perspective. K. Toda, A. Salazar and K. Saito. Berlin; New York, Springer). Dry powder coating processes have been used to create a hard finish that is tougher than that conventional solvent-based paint can achieve. Today, powder coatings are mainly used for coating metals such as household appliances and parts for bicycles, motorcycles and automobiles. Dry powder coating processes have not been previously used for fabricating electrodes for electrochemical energy storage. U.S. Pat. Nos. 8,815,443, 8,213,156 7,935,155 and 7,791,861 provide a sample background on the state of the art, all of which are hereby incorporated by reference in their entirety.

### SUMMARY OF THE INVENTION

The present invention integrates the state-of-the-art in two seemingly unrelated technologies: (1) materials for high energy and high power density electrochemical energy storage and (2) dry powder-coating processes for making protective, durable coatings. By successfully adapting and modifying electrostatic dry powder-coating, a mature technology in the paint and coating industry, the present invention demonstrates that battery electrodes can be made at lower cost, more rapidly and with less negative environmental impact than conventional manufacturing processes.

The dry powder coating technology applied to manufacturing high energy and high power density electrochemical energy storage provides a transformative development that allows for reducing the cost of electrode manufacturing—specifically lowering electrode manufacturing costs by up to 90%—and enabling novel electrode compositions and structures, such as flexible, non-rigid electrodes, electrodes with gradient composition, and thick electrodes.

### BRIEF DESCRIPTION OF THE DRAWINGS

FIG. 1 shows SEM images of an NMC-rich layer (A), a PVDF/CB layer (B), and a PVDF layer after thermal treatment, deposited by a solvent-free dry powder-coating process (C). For comparison, an NMC electrode made by a conventional wet-slurry coating process is shown (D).

FIG. 2 shows an example of a free-standing, flexible, multi-layered, LIB positive electrode consisting of NMC/PVDF/CB: CB layer (A), NMC layer (B), and cross-sectional view (C).

FIG. 3 shows cell potential vs. state of charge for the first charge/discharge cycle of dry powder-coated (A) and slurry-coated (B) NMC/PVDF/CB electrodes.

FIG. 4 shows capacity retention (A) and coulombic efficiency (B) vs. cycle number for batteries containing dry powder-coated and slurry-coated NMC/PVDF/CB electrodes.

FIG. 5 shows an illustration of an electrostatic dry-powder coating process for making cathodes containing LiNi_{1/3}Mn_{1/3}Co_{1/3}O₂(NMC), carbon black, and PVDF.

FIG. 6 shows mass percent vs. temperature of electrode mixtures before and after electrostatic dry-powder-coating, as determined by thermogravimetric analysis (TGA) under nitrogen atmosphere (A), and TGA for pure PVDF, CB, and NMC (B).

FIG. 7 shows scanning electron microscopy (SEM) images of the dry powder mixture before processing (A) and after dry-powder coating (B). Top view of the dry-powder-coated electrode after calendaring (C) and of a wet-slurry coated electrode after drying and calendering (D).

FIG. 8 shows scanning electron microscopy (SEM) images of the cross-section of the dry-powder-coated electrode after calendering (A) and magnified cross-sectional view (B). A cross-sectional view of the wet-slurry-coated electrode is in (C). Energy dispersive spectroscopy (EDS) maps of the elements carbon (D), oxygen (E), fluorine (F) that correspond to image (F).

FIG. 9 shows potential vs. capacity profiles of the dry-powder-coated cathode in lithium half cells, (A) showing cycle numbers 1, 5, 10, 15, and 20, for cells cycled from 3.0 to 4.3 V at 0.5 C followed by constant voltage with current limitation of C/20 after charging step. (B) shows discharge capacity at variable charging for the NMC cathode in lithium half cells. (C) shows discharge capacity (left) and capacity retention (right) for a wet-slurry-coated NMC cathode and a dry-powder-coated NMC cathode in lithium half cells cycled from 3.0 V and 4.3 V at rate of 0.5 C.

### DETAILED DESCRIPTION

Dry Powder Paint and Coatings Technology:

Unlike liquid paint, which uses an organic solvent or water, dry powders of paint are electrostatically sprayed in granular form. The application process involves applying a charge to the particles and spraying them onto a grounded substrate (the piece to be coated) for curing. In addition to providing a higher percentage of materials utilization, dry powder-coating processes, compared to wet paints and slurries, produce little or no volatile organic compounds (VOCs). Stringent regulation of VOCs was the initial driver for the technology but other advantages of dry powder coating have made it a preferred technology in the finishing and coating industry. For example, compared to conventional wet painting technologies, a cost reduction of 39.4% has been reported for dry powder coating in an EPA study based on Total Annual Cost comparison of several conventional and powder paint manufacturers (U.S. Environmental Protection Agency (1989). Powder Coatings Technology Update. EPA-450/3-89-33, October 1989). The process is not limited to painted surfaces; dry powder is used in coatings for food and pharmaceutical products (Khan, M. K. I., M. A. Schutyser, K. Schroen and R. M. Boom (2012). “Electrostatic powder coating of foods—state of the art and opportunities.” Journal of Food Engineering 111(1): 1-5; Sauer, D., M. Cerea, J. DiNunzio and J. McGinity (2013). “Dry powder coating of pharmaceuticals: a review.” International Journal of Pharmaceutics 457(2): 488-502).

Conventional Electrode Manufacturing Technology:

Commercial lithium-ion battery (LIB) electrodes are currently made by wet processes involving slurry mixing, casting, drying, and calendering as standard steps. These lithium-ion cell fabrication steps contribute significantly to the current overall pack cost of $400-600 kWh⁻¹, much higher than $125 kWh⁻¹, the EV Everywhere energy storage targets for 2022 (U.S. Dept. of Energy (2013). EV Everywhere Grand Challenge Blueprint see:energy.gov/sites/prod/files/2014/02/f8/eveverywhere_blueprint.pdf).

In conventional manufacturing of battery electrodes, the most common preparation involves processing of slurries, which are coated onto Al or Cu foils, then dried and calendared. Commercial electrodes contain lithium metal oxide (cathode) or graphitic (anode) particles, conductive filler, and polymer binder. Electrode particles and conductive filler are mixed, then ball-milled with a solution of the polymer binder. Alternatively a planetary mixer can be used, sometimes after kneading slurries into a thick paste. After mixing, electrode slurries are coated onto metal current collectors, uniformly distributing the material with a slot die, doctor blade, or reverse roll coating equipment. The dried electrode is calendared with a roller press machine, for a more even coating.

Materials for LIB electrodes include the lithium-intercalation materials, conductive filler, and polymer binder (Thackeray, M. M., C. Wolverton and E. D. Isaacs (2012). “Electrical energy storage for transportation—approaching the limits of, and going beyond, lithium-ion batteries.” Energy & Environmental Science 5(7): 7854; Lestriez, B. (2010). “Functions of polymers in composite electrodes of lithium ion batteries.” Comptes Rendus Chimie 13(11): 1341; Lux, S., F. Schappacher, A. Balducci, S. Passerini and M. Winter (2010). “Low cost, environmentally benign binders for lithium-ion batteries.” Journal of the Electrochemical Society 157(3): A320-A325). The cathode consists of a lithium metal oxide such as lithium cobalt oxide (LiCoO₂), lithium nickel manganese cobalt oxide (NMC), or lithium iron phosphate (LiFePO₄). The anode contains different forms of carbon or graphite, or, more recently, silicon or tin. In each case conductive fillers are used, which may consist of acetylene black, Ketjen black, and graphite. The polymer binder ranges from commonly utilized poly(vinylidenedifluoride) (PVDF) to ethylene propylene diene methylene linkage (EPDM), carboxymethylcellulose (CMC), or styrene butadiene rubber (SBR latex). For slurry processing, the polymer is dissolved in N-methylpyrrolidinone (NMP) to create a viscous solution.

A process that would eliminate this and other solvents would have multiple advantages. Despite its favorable properties for electrode deposition, NMP is hazardous to workers. Other solvents that dissolve PVDF, including tetrahydrofuran and dimethyl sulfoxide, are similarly harmful and—like NMP—are readily absorbed through the skin. In addition to these health hazards, significant costs involved in the solvent drying and recovery process (ca. $31 kWh⁻¹), could be eliminated if solvent use could be avoided.

TABLE 1
Similarities and differences between paint and electrode manufacturing

| | Paint, finishes, and coatings | Electrode fabrication |
|---|---|---|
| Materials | polymer binder (e.g., urethane and | polymer binder (e.g., polyvinylidene |
| | epoxy) | fluoride, sodium carboxymethyl cellulose |
| | | (CMC) |
| | fillers (e.g., granular solids such as | active material (e.g., lithium nickel |
| | TiO₂ incorporated to impart | manganese cobalt (NMC) oxide, lithium |
| | toughness, texture, or special quality) | iron phosphate, graphite, lithium |
| | | titanate, and silicon) |
| | pigments for coloring (e.g., carbon | electrically conducting material (e.g., |
| | black, dioxazine, and iron oxides) | carbon black) |
| | solvent (e.g., acetone, xylene, water) | solvent (e.g., N-methyl-2-pyrrolidone |
| | | (NMP), water) |
| Processes | wet (brushes, paint rollers, blades, | wet (mixing, casting, drying) |
| | spray, electrospray), drying | |
| | dry (electrostatic spray, extrusion, | Present Invention |
| | mechanical attachment (e.g., mold-in- | |
| | color)) | |

Application of Dry Powder Coating Process for Electrode Fabrication:

Table 1 shows that, although there are many parallels between paint and electrodes in terms of materials and processes, there are also significant differences. For example, both products include polymers, solid particles, and solvents as constituents and both require good adhesion to substrates as well as cohesion (within the paint and the electrodes). On the other hand, substantial differences exist: typical paint products are electrically insulating, except for special coatings for blocking electromagnetic interferences while electrodes must be electronically and ionically conducting. Again, in paint, polymeric binders occupy the larger volume fraction (ca 70% vol.) relative to fillers and pigments, whereas for high capacity electrodes, the volume fraction of the active materials should be as high as possible. Lastly, product requirements are quite different: paint is usually smooth, dense, and visually appealing, while electrodes are typically porous with high surface areas.

In general, three important ways to achieve significant system cost reduction have been identified: (1) lower the electrode processing cost of the costly organic solvent and primary solvent drying time; (2) substantially increase the electrode thicknesses to ^{˜}2× the current “power” levels (to 3.5 to 4.5 mAh/cm²) while preserving power density; and (3) reduce the formation time associated with the anode solid electrolyte interface (SEI) layer. The present invention provides an approach to address at least the first two: eliminating the use of solvents and associated drying time with a dry powder process and increasing electrode thickness.

The present invention provides for a dry method of producing an electrode though electrostatic spray deposition. The method includes mixing and/or milling dry powders of an active material, a binder and an electrically conducting material and depositing by electrostatic spray deposition on a surface, such as a metal surface (aluminum or copper foil). The mixture may be applied to the surface a fixed distance. A typical distance between the spray gun and the foil is about one width of the foil to ensure uniformity. The optimal distance can be adjusted by changing the air pressure (high pressure may counteracting the electrostatic attraction) and the applied voltage (the voltage ranges from 15 to 100 kV). With large distance the efficiency of spray may decrease because of the effect of the gravity on the sprayed particles.

The mixture may be applied at an angle with respect to the surface. The mixture may be applied to a surface of a mold. For depositing the electrode on one side of the metal foil, the spray gun should be positioned close to the direction of the metal foil. For depositing electrodes on both sides of the metal foil, the spray gun can be positioned along the plane of the foil and 90 degrees from the foil normal. The mixture may be applied to a surface of a mold. The mixture may be deposited for sufficient time to achieve a desired electrode thickness, such as between 10 to 500 micrometers. Because multiple sprayed guns can be used simultaneously, the production line speed can be multiplied by using several spray guns. The mixture may be applied to a gradient, such that an electrode with varying thickness is achieved. Following electrostatic deposition, the applied mixture may be calendered and further processed to a desired size and/or shape and then incorporated as an electrode within a battery system.

The dry components of the mixture to be electrostatically deposited comprise an active material, a binder and an electrically conducting material. By way of example, active materials include graphite, carbon, carbon nanotubes, carbon nanoribbons, carbon coated natural graphite, germanium (Ge), silicon (Si), titania (TiO2), tin oxides, LiCoO₂, Li(Ni_{1/3}Co_{1/3}Mn_{1/3})O₂, LiFePO₄, LiFeSiO₄ and LiMn₂O₄, LiAlMnO₄, LiNiO₂, LiNi_{0.8}Co_{0.2}O₂, LiNi_{0.8}Co_{0.15} Al_{0.05}O₂, LiMn_{0.5}Ni_{0.5}O₂, Li_{1.06}Mg_{0.08}Mn_{1.88} O₄. Binders can include polyvinylidene fluoride (PVDF), Polytetrafluoroethylene (PTFE), poly(acrylic acid) (PAA), Polyvinyl alcohol (PVA), Poly(butyl methacrylate) (PBMA), sodium alginate, polyamide, polyacrylate, polyurethane, ethylene propylene diene monomer (EPDM), carboxymethyl cellulose (CMC), styrene butadiene rubber (SBR) binders, sulfonated tetrafluoroethylene based fluoropolymer-copolymer (such as Nafion), shape memory polymers shape, or conducting polymers. Electrically conductive materials include carbon black, carbon nanotube, graphene, conducting oxides, graphite nonaqueous ultrafine carbon (UFC), and conducting polymers.

Each component of the mixture may be prepared to a desired powdered size (nano- to micro-meter size particle size) prior to assembling the mixture. Each component may be optionally processed to remove water vapor, such as incubation with a dessicator. Each component may be added at a desired ratio or proportion of the final mixture, depending on whether the electrodes are for high energy or high power applications. For example, high loading of active materials and large thickness are preferable for high energy batteries, whereas high porosity and thin electrodes are more suitable for high power batteries.

The active material, binder and electrically conducting material can be mixed together in a suitable device prior to electrostatic spray deposition, such as in a drum or a hopper. Once sufficiently mixed, with each component relatively uniformly dispersed through the mixture, the mixture can be moved to a spray gun, such as through application of an air supply. The mixture may be applied through more than one spray gun. Once the mixture is in the electrostatic spray gun, a charge is applied to the mixture, such as a direct current of 15 to 100 kV and it is sprayed through an opening of the gun toward the surface.

Alternatively to pre-mixing the active material, the binder and the electrically conductive material, each may be separately applied to the surface by electrostatic deposition. The may be applied simultaneously through different spray guns, or the may be applied sequentially in any order.

By eliminating organic solvents, and thereby limiting the environmental impact of electrode fabrication and the exposure of workers to harmful chemicals, is a significant benefit of the present invention. In addition, the present invention permits a wide variety of polymer binders to be used in battery electrodes. Through control of the chemical structure, molecular weight, polydispersity, and other properties of polymers, it may be possible to tune the characteristics of the polymer binder to yield more desirable results, a possibility hindered by solution-phase processing. By altering the thermal transitions of the binders, and increasing polymer conductivity and adhesion to metals and electrode particles, we will be able to test parameters currently not possible with the traditional NMP-based slurry processing route. Self-healing polymers can be utilized. Polymers containing Diels-Alder moieties can thermally rearrange during the thermal treatment process or in heating after extended cycling. Because the reaction is reversible, it can be used to reconstruct bonds when polymers rearrange due to particle fragmentation, thus “healing” damage caused by mechanical fatigue. Shape memory polymers can be utilized as binders for self-healing.

The present invention may further comprise assembling solid electrodes and solid electrolytes, such as ceramic electrolytes and polymer electrolytes. It has been recently identified that sulfide compounds (Tatsumisago M, N. M., Hayashi A (2013). “Recent development of sulfide solid electrolytes and interfacial modification for all-solid-state rechargeable lithium batteries.” Journal of Asian Ceramic Societies 1: 17-25) exhibit significantly high lithium ion conductivity (10⁻² S cm⁻¹), i.e., comparable to that of liquid electrolytes. Other solid electrolytes include oxides, phosphates, solid polymer electrolytes, and polymer gel electrolytes (see, e.g., Fergus, J. W. (2010). “Ceramic and polymeric solid electrolytes for lithium-ion batteries.” Journal of Power Sources 195: 4554-4569, incorporated herein by reference in its entirety). Utilizing solid such electrolytes with high lithium-ion conductivity allows for development of economically feasible manufacturing processes. The dry powder coating methods disclosed herein not only avoid costly vacuum technologies, but also allows fabrication of all the three components of an all-solid-state lithium-ion battery (LIB) (electrolyte and electrodes) using only one fabrication methodology. The present invention allows for simplified production with more effective control over the process variables.

The present invention also provides a method of assembling a solid battery comprising electrostatic deposition of an electrode as described herein, followed by electrostatic deposition of a solid electrolyte, followed further by electrostatic deposition of a second electrode. A conductor, such aluminum or copper foils or carbon papers, may then be attached to an electrode to complete assembly of the solid battery.

In addition to methods of producing electrode and solid lithium-ion batteries, the present invention may further or additionally comprise coating of all battery components from one manufacturing station, thereby allowing utilization of promising yet air- and humidity-sensitive lithium-ion conducting electrolytes, e.g. sulfides. Thus, the present invention is applicable as a scalable methodology for economically feasible production of all-solid-state batteries. In addition to the cost savings associated with dry electrode processing (10%), deposition of thicker electrodes (2%), extra cost savings will lead to production of all-solid-state batteries at an even lower cost than the conventional LIBs (less than $200/kWh). The sources for the extra cost savings are the elimination of wetting and SEI formation cycling (6%), elimination of the need for polymeric separator (12%), and deposition of electrodes and electrolyte in one step, which means less labor cost and less manufacturing hardware (10-20%). Three times higher energy density and improved cycle life and safety are other cost savings in all-solid-state batteries. Controlled deposition of electrode and electrolyte layers to design cells with gradient composition for enhanced utilization of the components is another further advantage provided by the present invention.

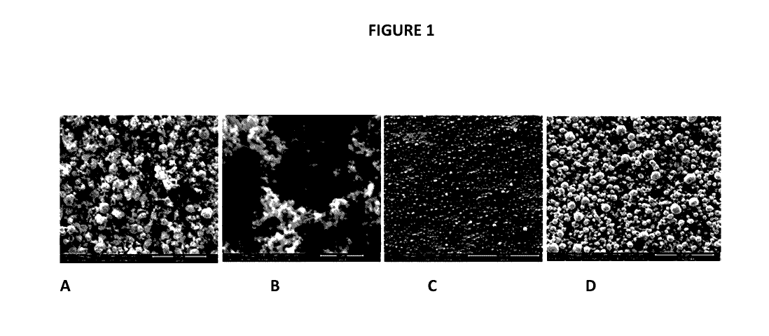

FIG. 1 demonstrates that a NMC/PVDF/carbon black electrode can be deposited by a solvent-free dry powder coating process. While electrodes have been deposited through spraying techniques, no publications have reported the solvent-free dry powder coating process we have achieved here. Furthermore, the components of the electrode can be deposited either individually from pure powders or simultaneously from a mixture of powders, allowing greater manufacturing flexibility and wider choices of materials.

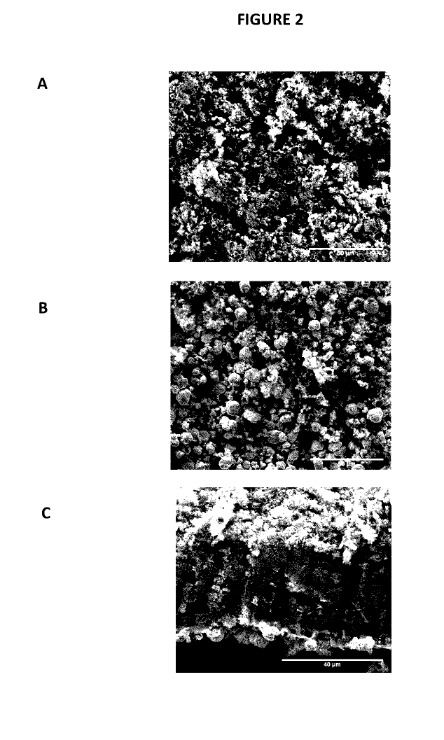

As an example of an electrode, a free-standing, flexible, multi-layered, LIB positive electrode comprising NMC/PVDF/CB is shown in FIG. 2. The electrode was deposited sequentially by a dry powder-coating process, followed by a baking step to fuse the electrode components without causing strong adhesion to the metal foil. i.e., the components were sprayed one-after-another by a dry powder-coating process, followed by a baking step to fuse the electrode components without causing strong adhesion to the metal foil. The free-standing electrodes were then detached from the metal and incorporated into a coin cell for electrochemical measurements.

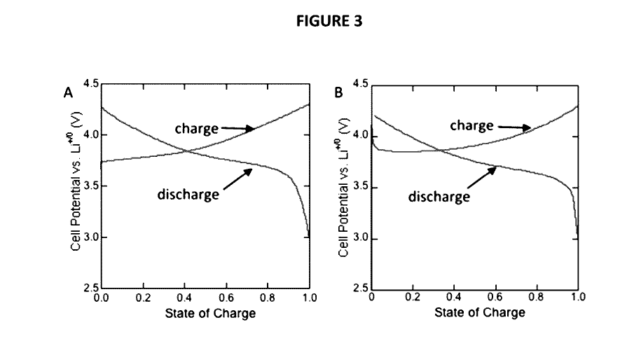

FIG. 3A shows the electrochemical behavior for the first cycle of this free-standing, flexible, multi-layered NMC/PVDF/CB electrode tested in the coin cell configuration. To compare to a conventional-processed electrode, an NMC electrode was made by a slurry process and tested in the same coin cell configuration. The first-cycle electrochemical behavior of this cell is shown in FIG. 3B. Notably, the voltage profiles for charge-discharge cycles for dry powder-coated electrodes are quite similar to those of the traditional slurry-processed electrodes, indicating that: (1) the cells can be cycled electrochemically, (2) the internal resistance is comparable, and (3) the NMC is fully utilized.

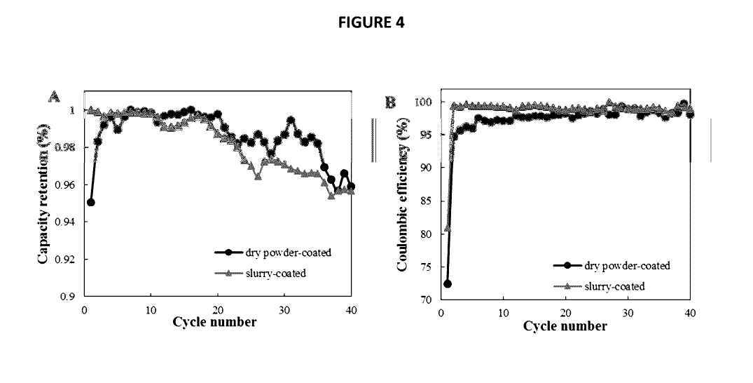

The retention of capacity with cycling for the dry powder-coated electrode (FIG. 4A) is slightly higher than that of the electrode made by the conventional slurry process. The initial coulombic efficiency for the dry powder-coated electrode is somewhat lower than that of the traditionally-processed NMC electrode (FIG. 4B), but the two approach the same efficiency after about 25 cycles. This initial difference may be attributed to the formation of solid-electrolyte interphase (SEI) on the relative large surface area and pores of the dry-powder coated electrode. After the SEI stabilizes, the coulombic efficiency of the electrodes is comparable.

While several embodiments have been described in detail, it will be apparent to those skilled in the art that the disclosed embodiments may be modified. Therefore, the foregoing description is to be considered exemplary rather than limiting.

### Examples

### EX. 1: Solvent-Free Dry Powder Coating Process for Low-Cost Manufacturing of LiNi_{1/3}Mn_{1/3}Co_{1/3}O₂ Cathodes in Lithium-Ion Batteries

The following describes a solvent-free dry powder coating process for making LiNi_{1/3}Mn_{1/3}Co_{1/3}O₂ (NMC) cathodes in lithium-ion batteries. This process eliminates volatile organic compound emission and reduces thermal curing time from hours to minutes. Here a mixture of NMC, carbon black, and poly(vinylidene difluoride) was electrostatically sprayed onto an aluminum current collector, forming a uniformly distributed electrode of controlled thickness and porosity. Charge/discharge cycling of the dry-powder-coated electrodes in lithium half cells yielded a discharge specific capacity of 155 mAh g⁻¹ and capacity retention of 80% after 300 cycles when the electrodes were tested from 3.0 to 4.3 V at a rate of C/5. Comparing with the conventional wet slurry-based electrode manufacturing method, the long-term cycling performance and durability of dry-powder coated electrodes are similar to those made by the conventional wet slurry-based method, and offers a potentially lower-cost, higher-throughput, and more environmentally friendly manufacturing process.

I. Introduction

Lithium-ion batteries (LIBs) dominate the market of energy-storage systems utilized in portable consumer electronic devices due to their high operating voltages, high rate capabilities, and long cycle lifetimes (Goriparti et al., Journal of Power Sources 257 (2014): 421-443; Nitta et al., Particle & Particle Systems Characterization 31, no. 3 (2014): 317-336; Obrovac et al., Chemical reviews 114, no. 23 (2014): 11444-11502; Zhang et al., Advanced Energy Materials 4, no. 4 (2014); Zhang et al., Science China Materials 57, no. 1 (2014): 42-58; Wang et al., Advanced materials 24, no. 14 (2012): 1903-1911).

While LIBs are the choice energy storage system for portable devices, state-of-the-art LIBs are behind targets needed for widespread adoption in vehicular applications and large-scale stationary storage systems. The Department of Energy suggests that energy-storage systems must meet a cost target of $125 kWh to meet requirements for widespread adoption, which would require a three- to four-fold reduction in system costs (D. Howell, Fiscal Year 2013 Annual Progress Report for Energy Storage R&D, U.S. Department of Energy, Office of Energy Efficiency and Renewable Energy, Vehicle Technologies Office, 2013, p. 2). In a recent publication, Wood and coworkers suggest (1) reducing electrode processing costs associated with organic solvents and their drying time and (2) increasing electrode thickness without compromising power density as two ways to significantly reduce system costs in LIBs (Wood et al., Journal of Power Sources 275 (2015): 234-242).

The most commonly employed, wet-slurry-based coating method for electrode fabrication involves the mixing active material, polymer binder, and conductive filler in a solvent, which is then coated onto current collectors, dried, and calendered. N-methylpyrrolidone (NMP) is the most commonly utilized organic solvent in electrode deposition. Evaporation of NMP requires a significant energy investment, as electrodes must be dried for several hours at temperatures as high as 120° C. to remove this solvent (Huang et al., U.S. patent application Ser. No. 13/850,346, filed Mar. 26, 2013). Because of its high cost and potential as an environmental pollutant, solvent recovery is necessary in commercial applications, adding further costs to battery fabrication (Wood et al., Journal of Power Sources 2015, 275, 234-242). Numerous research groups have explored the possibility of removing organic solvents from electrode fabrication to reduce costs and environmental impact.

By replacing traditionally utilized poly(vinylidene difluoride) (PVDF) with polymer binders such as carboxymethyl cellulose (CMC), alginate, and fluorine acrylic latex (TRD 202A), water can be used in place of NMP as the main solvent for electrode deposition (Doberdò et al., Journal of Power Sources 248 (2014): 1000-1006; Loeffler et al., Journal of Power Sources 248 (2014): 915-922). In several publications, water-based slurries have been reported to create electrodes with comparable performance to those fabricated with NMP (Xu et al., Journal of Power Sources 225 (2013): 172-178; Wu et al., Electrochimica Acta 114 (2013): 1-6). However, while this solution eliminates the use of organic solvents, the time-intensive, energy-demanding drying step remains. For this reason, new methods of electrode fabrication have been explored that eliminate the use of solvents altogether.

Solvent-free coating processes utilizing dry particles are the ideal solution to wet-slurry-based manufacturing processes, as they eliminate the cost of solvents, their removal, and—for organic solvents—their recovery. Solvent-free manufacturing has been achieved through pulsed-laser deposition, a method in which a laser is focused on to-be-deposited electrode components. This technique requires high vacuum (10⁻⁶ Torr) and high annealing temperatures (>600° C.), producing only thin films of cathode material (<500 nm), and is therefore impractical for large-scale fabrication. While RF magnetron sputtering can be used with lower temperature substrates (350° C.), but require expensive instrumentation and inert atmospheres, again impractical for large-scale electrode fabrication (Shiraki et al., Journal of Power Sources 267 (2014): 881-887; Kuwata et al., Electrochemistry Communications 6, no. 4 (2004): 417-421; Chiu et al., Thin Solid Films 515, no. 11 (2007): 4614-4618).

Another method for dry-powder coating is electrostatic spray deposition (ESD), a solvent free technology that has been used in coating industries for over 30 years to create decorative and functional paints and coatings. This method eliminates the release of volatile organic compounds (VOCs), reduces energy consumption, increases paint material transfer efficiency, and improves painted-surface quality. In ESD, particles are charged as they pass through a charging gun, and are deposited onto a grounded surface (Bailey et al., Journal of electrostatics 45, no. 2 (1998): 85-120). This method can be used on large particles and is easily scalable, offering high deposition rates onto large surfaces (Mazumder et al., Journal of electrostatics 40 (1997): 369-374).

Recently Hiroya et al. reported the fabrication of cathodes using a tribo-charging gun using a polytetrafluoroethylene (PTFE) gun, which produces mostly positively charged particles. The cathodes contained LiCoO₂ particles (LCO, ^{˜}2 um in diameter) as the active material, carbon black particles (^{˜}40 nm) as the conductive filler, and poly(methyl methacrylate) particles (^{˜}100 nm) as the binder coated onto aluminum current collectors at room temperature. These subsequently roll-pressed electrodes ca. 70 um thick were reported to have a capacity of ca. 140 mAg g⁻¹ in lithium half cells charged at 0.1 C, suggesting compatibility in commercial LIBs, although data was only reported for one cycle (Hiroya et al., Transactions of JWRI, 2015, 44, 9). More recently Ludwig et al. reported the use of ESD, followed with hot-rolling treatment, to create 40-130 μm thick cathodes containing a 90:5:5 ratio of LCO:carbon additive:PVDF with ca. 30% porosity, which delivered specific capacity of 121 mAhg⁻¹ at a charging rate of 0.1 C in lithium half cells (Ludwig et al., Scientific reports 6 (2016)). Similarly prepared cathodes containing LiNi_{1/3}Mn_{1/3}Co_{1/3}O₂ (NMC) as the active material were also reported, showing 138 mAhg⁻¹ in lithium half cells (Ludwig et al., Scientific reports 6 (2016)).

In this study, we sought to (1) demonstrate laboratory scale solvent-free dry powder coating processes for making LIB cathodes, and (2) compare the performance and durability of electrodes made by dry powder coating processes with that by wet slurry coating processes and to other cathodes prepared by this method.

II. Experimental

Electrode Fabrication

Dry-Powder-Coated Electrodes.

To prepare the dry cathode mixture, LiNi_{1/3}Mn_{1/3}Co_{1/3}O₂ (NMC, Umicore) was mixed with carbon black (CB, Super p C65, Timical) in a planetary mixer-deaerator (Mazerustar KK-505, Kurabo) for 20 min. The NMC particles sizes are between 5.6 μm and 12 μm (D₅₀=10.0). The resultant mixture was combined with poly(vinylidene difluoride) (PVDF, kf, 1100, Kureha America) to create a mixture of NMC:CB:PVDF of 19:1:1, which was mixed in a ball mill (8000M Mixer/Mill, SPEX) for 30 min.

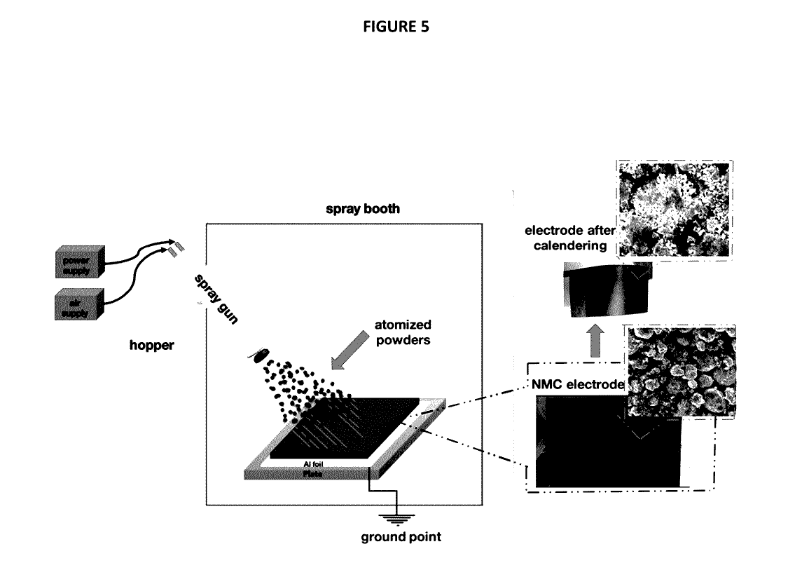

The electrostatic dry-powder-coating process for electrode fabrication utilized a corona-type electrostatic spray gun (FIG. 5), set up inside a spray booth to capture loose powder, which was used to spray the powder mixture onto an electrically grounded Al foil (15 μm thick). The DC voltage between the gun and Al foil was set at 25 kV. Compressed air (15 psi) was used to transport the powder mixture from the hopper to the spray gun. The distance between the tip of the spray gun and the substrate was fixed at 20 cm. The angle between the spray direction and the normal of the Al foil was 45°. The thickness of the sprayed layer was controlled by keeping the spraying time to 1 min. The dry-powder-coated electrodes were transferred to the oven and heated in air for 1 h at 170° C. Then the baked electrodes were calendered at room temperature with specified gap spacing by a compact electrical rolling press (MTI Corp.). 12 mm diameter discs were cut using a Precision Disc Cutter (MTI Corp.) and transferred to the glove box to be ready to assemble the coin cell.

Slurry-Coated Electrodes.

For comparison, slurry-based electrodes were prepared from NMC, CB, and PVDF (19:1:1 wt. ratio) suspended in N-methyl-2-pyrrolidone (NMP, BASF) (84% volume fraction of NMP). The slurry was blended in a homogenizer at 4000 rpm for 1 h (Polytron PT 10-35 GT, KINEMATICA) and afterward was casted onto Al foil (15 μm think) using a compact-tape casting coater with integrated dryer and vacuum chuck (MTI Corp.). The adjustable doctor blade was set at 200 μm, and films were cast at a speed of 0.2 m min⁻¹. The electrodes were dried in air overnight and calendered in a compact electric rolling press (MTI Corp.) with adjusted clamping force at room temperature. After calendering, 12 mm diameter discs were cut using a Precision Disc Cutter (MTI Corp.) after which they were placed in a vacuum oven at 130° C. for 12 h.

Electrode Characterization

Morphology.

Using an Environmental Scanning Electron Microscopy (ESEM) with Energy Dispersive Spectroscopy (EDS/EDX) (Quanta FEG 250, FEI), we investigated the morphology and composition of the powders, as well as the surface and cross section of the electrodes made by the electrostatic spray and wet slurry coating processes.

Thermogravimetric Analysis.

Thermogravimetric analysis (TGA) was used to determine the mass ratios of the powder mixtures consisting of NMC, CB, and PVDF before and after electrostatic spraying. A TA Instruments Q500 Thermogravimetric Analyzer (USA) was operated under an air atmosphere and scanning rates of (10° C. min⁻¹) from room temperature to 800° C.

Assembling Coin Cells and Electrochemical Tests.

Electrodes were tested in CR2025-type coin cells (Hohsen). The coin cells were assembled using an automatic coin cell crimper (KTE-20S-D, Hohsen) inside the glovebox (MB-20-G, MBraun). The glovebox was filled with argon with water and oxygen levels below 1 ppm. Lithium metal foil (99.9%, Sigma-Aldrich) was used as the counter electrode. The electrodes were punched to 12 mm diameter discs by using a precision disc cutter (MTI Corp.). Poly-propylene (Celgard 2400) was used as separators between the lithium foil and the cathode. 1M LiPF₆ in ethylene carbonate/ethylmethyl carbonate (EC/EMC 3:7 by volume) with 2% vinylene carbonate (VC, BASF) was used as the electrolyte. The electrolyte weight ratios were 12.5 wt % LiPF₆, 25.7 wt % EC, 59.9 wt % EMC, and 2.0 wt % VC. A stainless steel spacer and spring were placed on the lithium metal to obtain a uniform current distribution and served as a current collector. The electrochemical characterization of the assembled cells was performed using a multi-channel potentiostat (VMP-3, Bio-logic) operated in the galvanostatic mode. Cell cycling was performed at room temperature with a 2 h resting period before each test. Charge/discharge tests were also performed at variable rates, ranging from 0.5 C to 10 C, cycling from 3.0 V and 4.3 V. The charging step is followed by constant voltage with current limitation of C/20.

### Results and Discussion

For this study, NMC was used as the cathode active material because of its high rechargeable capacity (150-200 mAh g⁻¹), high energy density (140-180 Wh/kg),[23] and high charge and discharge rate capability (Mohanty et al., Sci Rep 2016, 6, 265; Patel, P., Improving the Lithium-Ion Battery. ACS Cent Sci 2015, 1, 161-2; Wu et al., Journal of The Electrochemical Society 2012, 159, A438). To prepare materials for electrostatic spray deposition, NMC was first mixed with CB in a planetary mixer-deaerator. Afterward, PVDF was added, and the resultant mixture was blended in a ball miller, yielding a mixture containing NMC:CB:PVDF in a 19:1:1 wt. ratio. To prepare electrodes, the powder mixture was loaded into a hopper connected to a corona-type spray gun. Compressed air was run through the spray gun as a DC voltage of 25 kV was used to charge the powders and direct them to a grounded aluminum foil current collector. This setup, which was housed spray booth to capture the loose powders, is represented in FIG. 5.

The dry-powder-coated electrodes were transferred to an oven set at 170° C., close to the melting point of PVDF (177° C.) and were heated in air for 1 h. The heating temperature was close to melting point of PVDF to cause bonding mechanisms between PVDF and the solid particles (NMC and CB) and meanwhile not eliminate all the porosity of the electrode during melting (see, thelibraryofmanufacturing.com/pressing_sintering.html). The baked electrodes were calendered at room temperature to increase the cohesion between the particles and the binder and greatly strength the electrode, improve the adhesion between the coated materials and the Al foil, and to control the porosity, and the packing density of the electrodes. For comparison, electrodes with the same NMC, CB, and PVDF wt. ratio in the solvent NMP were fabricated using a wet-slurry-coating method, as described in the Experimental Section.

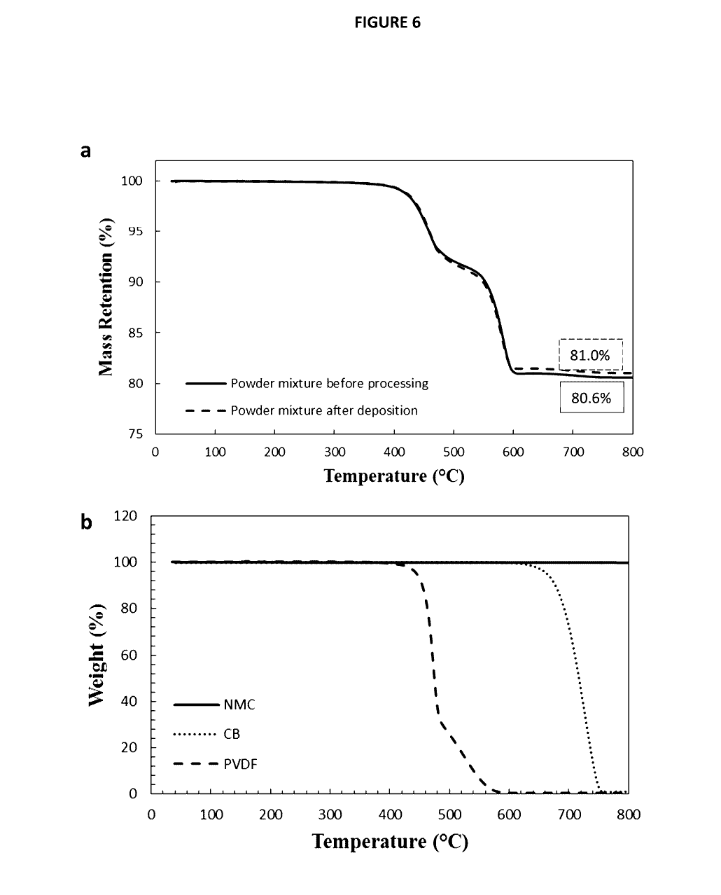

To determine whether the dry-powder-coated electrodes contained the same ratio of NMC:CB:PVDF, we analyzed the pre-mixed powder and that deposited on the Al foil using thermogravimetric analysis (TGA). For the mixed particles and coated electrode mixtures, mass loss trends (FIG. 6A) were nearly identical. Comparing the TGA plots of the mixtures to that of the components shown in (FIG. 6B), it is evident that the mass loss spanning ca. 400 to 460° C. corresponds to PVDF, whereas the loss from 500 to 550° C. corresponds to CB. In the temperature window analyzed, NMC does not loose mass, which is thermal stable (Malmonge et al., Materials Research 13, no. 4 (2010): 465-470; Campos et al., Materials Science and Engineering: B 136, no. 2 (2007): 123428; Geder et al., Solid State Ionics 268 (2014): 242-246).

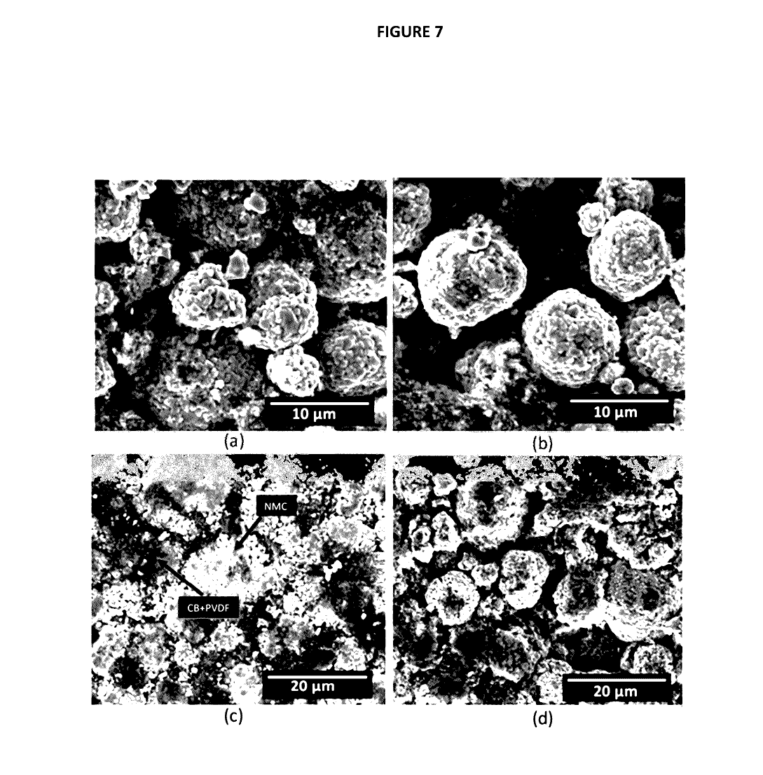

Scanning electron microscopy (SEM) was used to analyze the powder mixtures to determine whether the particles remained intact after electrostatic coating. SEM images (FIG. 7A-B) indicate that the NMC particles are intact after processing, as no appreciable morphological difference is observed before and after coating. A SEM image of the top surface of the as-prepared electrode after the curing and calendering steps (FIG. 7C) shows that the electrode is more dense after further processing. For comparison, a top view of a slurry-made electrode after drying and calendaring (FIG. 7D).

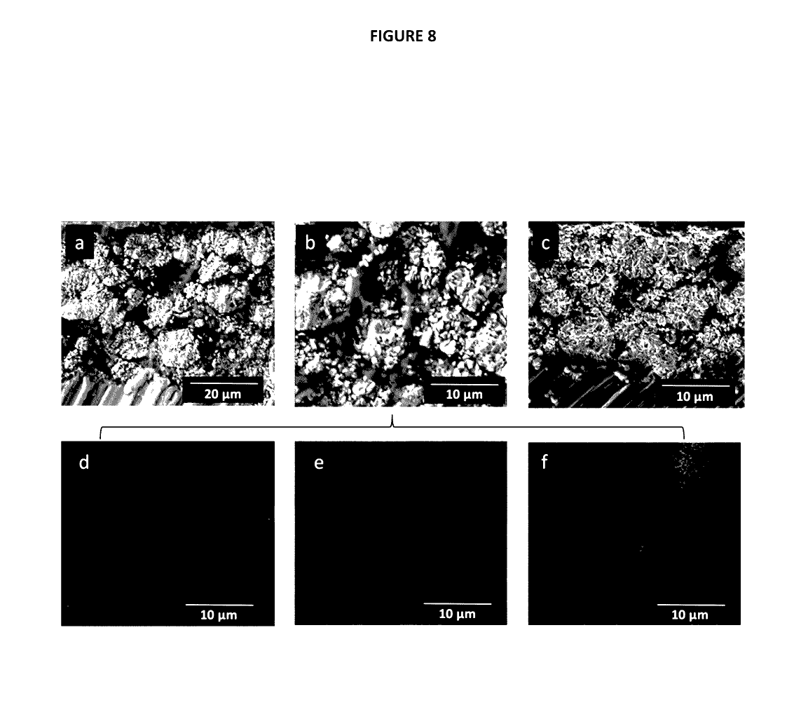

Cross-sectional SEM images of the dry-powder-coated electrodes after calendering are shown at two magnifications in FIGS. 8A-B. For comparison, the SEM cross-section image of an electrode made by the traditional slurry method is shown in FIG. 8C. The structures of the electrodes made by the two processes are similar. Energy dispersive spectroscopy (EDS) was used to map the elements carbon, oxygen, and fluorine (FIGS. 8D-F). Based on the oxygen and fluorine maps, respectively, the EDS maps shows that NMC and PVDF are dispersed throughout this portion of the sample. Although the carbon map shows the presence of carbon throughout the image, because carbon is present in both carbon black and PVDF, it is not possible to differentiate between these species.

The calendering process compacts the powders, improves the cohesion between the particles and the adhesion of the composite materials with the Al foil, and controls the porosity and the packing density of the electrodes (Zhu, Likun, Fluixiao Kang, Yongzhu Fu, and Cheolwoong Um. “Geometric and Electrochemical Characteristics of NMC Electrodes with Different Calendering Conditions.” (2016); Sheng et al., Frontiers in Energy Research 2 (2014): 56). The electrodes are well compacted after calendaring with a porosity of 31% and packing density of 2.5 g cm⁻³. For comparison, the conventional slurry-made electrode has a porosity of 35% and packing density of 2.7 g cm⁻³ as summarized in Table 2.

TABLE 2
The thickness, mass loading, porosity, density, and electrochemical
performance of electrodes made by the dry and wet processes

| | | Mass | | Packing | Discharge |
|---|---|---|---|---|---|
| | Thickness | loading | Porosity | density | capacity |
| Process | (μm) | (mg cm⁻²) | (%) | (g cm⁻³) | (mAh g⁻¹) |
| Dry powder | 40.5 | 10.07 | 31 | 2.5 | 155 |
| coating | | | | | |
| electrode | | | | | |
| Wet | 52 | 14.27 | 35 | 2.7 | 156 |
| slurry-based | | | | | |
| electrode | | | | | |

The electrochemical behavior of dry-powder-coated electrodes was analyzed in lithium half cells containing 1M LiPF₆ in EC/EMC (3:7 wt. ratio) containing 2 wt % VC. This electrolyte composition was chosen because the VC additive will improve the rate performance of the electrodes (Deshpande et al., Journal of The Electrochemical Society 162, no. 3 (2015): A330-A338). Plots of voltage vs. state-of-charge plot for the first cycle of the dry-powder-coated electrode is shown in FIG. 3A. For comparison, the first cycle electrochemical behavior to a wet slurry-made electrode is shown in FIG. 3B. Notably, the voltage profiles for charge-discharge cycles for the dry powder-coated electrodes are similar to that of the conventional slurry-coated electrodes.

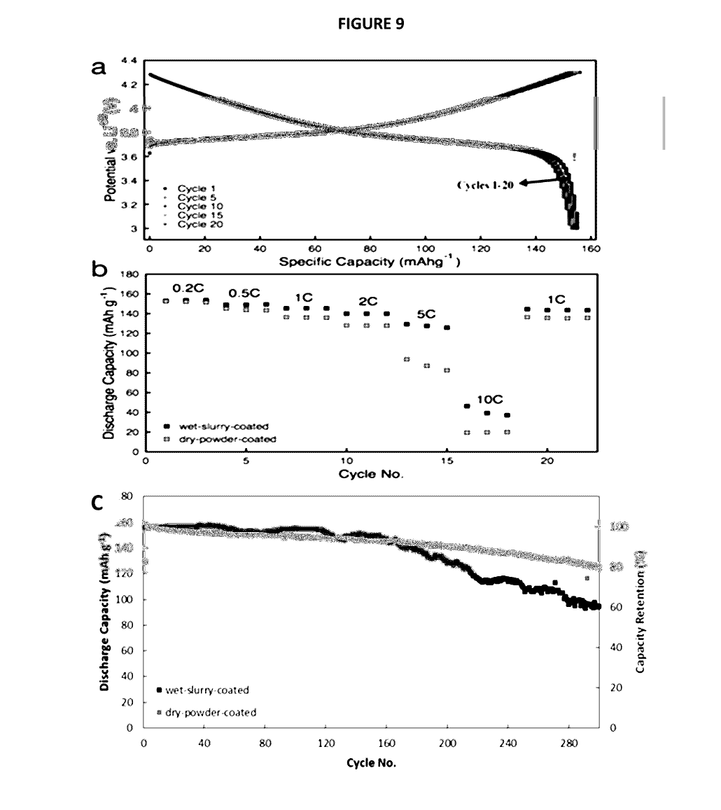

FIG. 9A shows the potential profile for cycles 1, 5, 10, 15, and 20 between 3.0 V and 4.3 V at 0.2 C followed by constant voltage with current limitation of C/20 at charging step. The initial discharge capacities fade slowly during cycling and show 155 mAh g⁻¹ and 153 mAh g⁻¹ for cycles 1 and 20, respectively. While for wet-slurry-coated electrode there is no capacity fade for the first 20 cycles.

To investigate the effect of different current rates on the cycling performance of the dry sprayed and slurry electrodes, the NMC cells were charged and discharged between 3.0 V and 4.3 V at various current rates, starting from 0.2 C and increasing to 0.5, 1, 2, 5 and 10 C, then back to 1 C, and the specific capacities were 156, 148, 139, 130, 96, 20, and 139 mAh respectively, as shown in FIG. 10B. The electrode started with high discharge capacity at the low C-rate (0.2 C) and dropped to 13% at high C-rate (FIG. 9C), then recovered to the previous capacity level when the C-rate returned to 1 C. At high rates, the electrodes will polarize and the plateaus of the NMC become shorter when the charging and discharging current densities increase, causing the capacity to drop (Xu et al., Journal of Power Sources 225 (2013): 172-178). For the slurry-coated electrode the discharge capacities for the same order of C-rates as the sprayed electrode were 153, 149, 145, 140, 129, 46, and 145 mAh g⁻¹, respectively. The small difference in the discharge capacities between the dry-powder and wet-slurry coated electrodes for current from 0.2 C to 1 C may come from the small differences in porosity and packing density of the electrodes.

FIG. 9C shows the long term cycling performance of the dry sprayed and the conventional slurry-made electrode between 3.0 V and 4.3 V at 0.2 C followed by constant voltage with current limitation of C/20 after charging step. For the dry-coated electrode, the first discharge capacity was 155 mAh g⁻¹, and the capacity retention was 80% and discharge capacity of 123 mAh g⁻¹ after 300 cycles. While for the slurry-made electrode, the first discharge capacity was 156 mAh g⁻¹ with capacity retention of 60% and discharge capacity of 97 mAh g⁻¹ after 300 cycles. It is demonstrated that the cycling performance of the dry sprayed NMC electrode is better than the traditional slurry-made electrode and has good performance and capacity retention, suggesting that (1) the internal resistance is comparable and (2) the NMC is fully utilized in both electrodes.

As reported by Ludwig et al. (Scientific reports 6 (2016)), they used ESD, followed by hot-rolling treatment, and demonstrated electrode discharge capacity retention of 121 mAhg⁻¹ in lithium half cells and capacity retention of 87% at 0.5 C over 50 cycles. In this work, we confirm that by pre-heat the electrode film after spray then calendering it at ambient temperature, the electrode shows an improvement in performance and cycling life. The discharge capacity retention is 123 mAhg⁻¹ with capacity retention of 80% over 300 cycles. This process is quite flexible and indeed promising.

### CONCLUSION

We demonstrated that a solvent-free dry powder coating process, in particular electrostatic spraying, can be used to fabricate NMC-containing cathodes for LIBs. The morphology of the powders and electrodes shows very well distributed particles in the coated layer, and that the binder is well dispersed in dry powder before and after spraying. Constant current charge-discharge test results show that the dry sprayed NMC electrodes with PVDF as binders and CB as a conductive agent exhibit high discharge specific capacity with very good capacity retention, comparable to conventional, wet-slurry-coated electrodes.

This work is important because (1) electrodes made by the dry powder coating process can indeed have reversible capacity and cycle life comparable with the electrodes made by the wet slurry method, (2) dry powder coating lowers the cost by reducing the mixing and slurry preparation steps and the reducing drying time, and (3) dry powder coating eliminates the pollution caused by NMP solvent. Since dry powder coating processes have significantly benefited the paint industry which faced the similar issues with the cost and environmental impact associated with solvents, we therefore believe that solvent-free dry coating processes, such as electrostatic spraying, will replace the traditional wet slurry method of making battery electrodes.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled. All documents referenced herein including patents, patent applications and journal articles and hereby incorporated by reference in their entirety.

We claim:

1. A method for fabricating an electrode comprising electrostatic spray deposition of a powder mixture on a surface, wherein the powder mixture comprises an active material, a binder and an electrically conductive material.

2. The method of claim 1, wherein the active material is selected from a first group consisting of graphite, carbon, carbon nanotubes, carbon nanoribbons, silicon (Si), germanium (Ge), titania (TiO₂), tin oxides, LiCoO₂, Li(Ni_{1/3}Co_{1/3}Mn_{1/3})O₂, LiFePO₄, LiFeSiO₄ and LiMn₂O₄.

3. The method of claim 1, wherein the binder material is selected from a second group consisting of polyvinylidene fluoride (PVDF), carboxymethyl cellulose (CMC), styrene butadiene rubber (SBR) binders, shape memory polymers, or conducting polymers.

4. The method of claim 1, wherein the electrically conductive material is selected from a third group consisting of carbon black, carbon nanotube, graphene, conducting oxides, and conducting polymers.

5. The method of claim 1, wherein the surface has a gradient to allow for the electrode to possess a gradient in composition and structure.

6. The method of claim 1, wherein the powder mixture is repeatedly applied such that the electrode has multiple layers in composition and structure.

7. The method of claim 1, wherein the surface is a metal foil selected from a fourth group consisting of an aluminum foil and a copper foil or carbon paper.

8. The method of in claim 7, wherein the powder mixture is deposited simultaneously on two opposing sides of the metal foil.

9. The method of claim 1, wherein the powder mixture is applied at a thickness of 10 to 500 micrometers to the surface such that the electrode is free-standing and flexible.

10. The method of claim 7, wherein the powder mixture is applied from a distance from the surface, wherein the distance is one width of the metal foil.

11. The method of claim 1, wherein the powder mixture is deposited on the surface by an electrostatic spray gun with a direct current charge of between 15 and 100 kV.

12. A method for fabricating an electrode comprising electrostatic spray deposition of an active material, a binder and an electrically conductive material to metal surface.

13. The method of claim 12, wherein the active material, the binder and the electrically conductive material are applied simultaneously.

14. The method of claim 12, wherein the active material, the binder and the electrically conductive material are applied sequentially.

15. The method of claim 12, wherein the active material, the binder and the electrically conductive material are applied as layers on the surface.

16. A method for fabricating a battery comprising:
electrostatic deposition of a first active material, a first binder, a first electrically conductive material to a surface to form a first electrode;
electrostatic deposition of a solid electrolyte onto the first electrode;
electrostatic deposition of a second active material, a second binder, a second electrically conductive material to form a second electrode; and,
attaching a conductor to the second electrode to form a battery.

17. The method of claim 16, wherein the solid electrolyte is a sulfide, oxides, phosphates, solid polymer electrolytes, and polymer gel electrolytes.

18. The method of claim 16, wherein the conductor is selected from a fourth group consisting of aluminum foil, copper foil and carbon paper.
